(19) United States
(12) Patent Application Publication
(10) Pub. No.: US 2003/0213438 A1
(43) Pub. Date: Nov. 20, 2003

(54) Stack of nested shelter components

(76) Inventors: Lucas Saxe, Laguna Beach, CA (US); Patrick Douglas, Minneapolis, MN (US); Michael Farmer, Southlake, TX (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/447,660

(22) Filed: May 28, 2003

Related U.S. Application Data
(63) Continuation-in-part of application No. 09/948,506, filed on Sep. 6, 2001, now Pat. No. 6,606,965.

(51) Int. Cl. A01K 1/02; A01K 1/03; A01K 31/00

(52) U.S. Cl. 119/482

(57) ABSTRACT

A pet shelter that enables efficient stacking of multiple. The shelter comprises a bottom section and a top section which nest together when stacked.

### REFERENCE TO RELATED APPLICATIONS

The present application is a continuation-in-part of U.S. patent application Ser. No. 09/948,506, filed Sep. 6, 2001, entitled “Stackable Pet Shelter,” and claims priority benefit under 35 U.S.C. § 120 to the same. The present application also incorporates the foregoing disclosure, herein by reference.

### BACKGROUND OF THE INVENTION

1. Field of the Invention

The invention relates to enclosures that are readily stackable so as to occupy as little retail space as possible. More particularly, the shelter includes a top section and a bottom section, and both the top and bottom sections fit snugly within each other when one section is inverted.

2. Description of the Related Art

Shelters that are available for purchase at retail stores are well known. Many of these shelters have a two-piece construction, consisting of a top section and a bottom section. Typically, the bottom section is a substantially rectangular box with a flat bottom and an open top. The top section is often shaped like a prism, with a triangular cross-section. This top section thus provides the shelter with a steeply sloped roof. This slope allows the roof to easily shed rain water, and discourages pets from climbing on top of the shelter.

U.S. Pat. No. Des. 349,980 to Northrop et al. discloses an ornamental design for a pet house. The house has a two-piece construction. The bottom section comprises a rectangular box with an open top and side walls that gradually slope outward from the bottom. The top section is shaped generally like a prism, with an open rectangular bottom and seven walls. The two end walls are generally hexagonal, the bottom edge of each being the longest edge. One end face of both the bottom and top sections includes a substantially U-shaped opening. When the top and bottom sections are assembled, the open ends of the U-shaped openings face each other, creating a substantially rectangular opening that serves as an entrance/exit for the shelter.

U.S. Pat. No. Des. 366,541 to Bradburn et al. discloses a doghouse that is remarkably similar in shape and design to the Northrop shelter. The main difference between the Bradburn and Northrop shelters is that the end faces of the top section of the Bradburn shelter have only five edges, whereas the end faces of the top section of the Northrop shelter have six edges.

In both the Northrop and Bradburn designs, the top section is readily insertible within the interior of the bottom section once the top section has been inverted. Because of the shapes and sloped edges of the top sections of both designs, however, the bottom section does not fit snugly within the interior of the top section. The base of the bottom section is too wide to fit very far into the open end of the top section. Thus, a stack of either of these shelters that was arranged bottom, top, bottom, top, bottom, etc. would be very unstable and quite high in relation to the number of shelters in the stack.

U.S. Pat. No. 5,551,371 to Markey et al. discloses a pet enclosure that has a generally hollow box-shaped base and a roof hingedly attached to the base. The roof is gable-styled, with triangular end faces. The side edges of each triangle slope sharply. The side edges of the bottom section slope very gradually. Therefore, the bottom section will not nest within the inverted top section.

U.S. Pat. No. 5,154,137 to Stanaland discloses a whelping box having a top section and a bottom section. Both sections are substantially rectangular boxes with open ends. The bottom section includes a removable insert having a ledge around the inside surface of three walls. The insert is nearly identical to the bottom section, but is slightly smaller for snug engagement with the interior of the bottom section. Even without the insert, the top and bottom sections are not capable of very efficient stacking. The sides of the top section include ventilation openings that protrude from the outer surface of each side. Thus, the openings obstruct the path of the inverted top section as it is slid into the bottom section. Furthermore, the ledge around the inside of the insert creates empty space beneath the ledge into which neither an inverted top section nor an inverted bottom section can advance.

In retail outlets, where pet shelters are often sold, display space is at a premium. Therefore, two-piece shelters are typically broken down into their separate sections so that the sections can be stacked, thereby maximizing the number of shelters per unit area of shelf space. Unfortunately, pet shelters having sloped roofs are not very amenable to efficient stacking. One way to stack these shelters is to create two stacks, one stack of bottom sections, and one stack of top sections. This method has the obvious drawback of occupying double the shelf space of a single stack. This method also disadvantageously requires additional warehouse space and is expensive to transport.

In order to eliminate one stack from the above method, another method of stacking is to place the stack of top sections upon the stack of bottom sections. This method reduces the amount of shelf space occupied by the two stacks, but makes the job of removing one pet shelter from the stack very difficult. When a customer wishes to purchase one of the shelters, he or she or a store employee must remove the entire stack of top sections from the stack of bottom sections in order to extract a bottom section. The stack of top sections is sometimes quite heavy, making this method very inconvenient.

Another method of stacking is to invert a top section and place it inside a bottom section. This method eliminates the difficulty of having to move a large stack of top sections in order to extract a bottom section. Depending upon the angle of slope in the top section, however, this method may create a large amount of empty space between the top and bottom sections. With very steeply sloped roofs, the top section may even lean to one side within the bottom section. Further, a second bottom section typically will not fit within the inverted top section, at least not without creating a very large amount of empty space between the two. Such a stack tends to be very unstable and unsafe. In addition the stack occupies a great deal of vertical space compared to the number of pet shelters in the stack.

Thus a pet shelter that is amenable to stacking in a bottom-top-bottom-top-bottom-etc. fashion would be of significant advantage to pet store owners and pet product consumers. The device should enable a stable stack that is comparatively short in comparison to the number of shelters in the stack.

### SUMMARY OF THE INVENTION

The preferred embodiments of the stackable pet shelter have several features, no single one of which is solely responsible for their desirable attributes. Without limiting the scope of this invention as expressed by the claims that follow, its more prominent features will now be discussed briefly. After considering this discussion, and particularly after reading the section entitled “Detailed Description of the Preferred Embodiments,” one will understand how the features of the preferred embodiments provide advantages, which include ready stackability in an efficient and stable manner.

Preferred embodiments of the stackable pet shelter comprise a bottom section and a top section that mate to form a sturdy shelter. The bottom section is shaped substantially as a hollow rectangular box having a floor and four side walls. The side walls slope outwardly, and a first side wall includes a substantially U-shaped opening. The legs of the U are bent slightly outward. The top section is shaped substantially as a hollow six-walled structure having two opposite rectangular walls, two opposite pentagonal walls and a peaked roof. The side walls slope outwardly away from the roof, and a first side wall includes a substantially U-shaped opening, with the legs of the U bent slightly outward.

The top and bottom sections are configured such that an inverted top section fits snugly within an interior of a bottom section, and a bottom section fits snugly within an interior of an inverted top section. Thus, preferred embodiments of the pet shelter enable efficient stacking of multiple shelters in a bottom-top-bottom-top-bottom-etc. arrangement. The bottom-top-bottom-top-etc. arrangement in one embodiment being constructed as nested pet shelters with a bottom and corresponding top of a first pet shelter being grouped together in the stack before another bottom and corresponding top of a second pet shelter in the stack. However, an artisan will recognize from the disclosure herein that many stacking methodologies can be used to effect at least one advantage of the present disclosure, i.e., the grouping together of nested pet shelter components for a given pet shelter within a stack of nested pet shelter components for many pet shelters. For example, an artisan will recognize from the disclosure herein that a bottom may nest in a corresponding top or vice versa. Moreover, any of the bottom or top may be inverted to accomplish such nesting.

Several features of the pet shelter contribute to its stackability. First, the side walls of the top and bottom sections slope at roughly equal angles. Second, the legs of the U-shaped openings are bent at roughly equal angles on both the top and bottom sections. Third, the height of the top section is roughly equal to the height of the bottom section. Fourth, the roof of the top section has a very gradual slope, such that the peak of the roof does not obstruct nesting of a top section within a bottom section.

In one embodiment, the height of the top section is different from the height of the bottom section. In another embodiment of the stackable pet shelter, the side walls of the top and bottom sections slope at different angles. In a further embodiment, the roof of the top section comprises at least one flat section.

In yet another embodiment, the stackable pet shelter comprises a support structure on the bottom section, the top section, or both the top and bottom sections. The support structure protrudes from the surface of the stackable pet shelter to prevent contact between the roof and the base when the top and bottom sections are nested. Additionally, in another embodiment, the support structure protrudes from the surface of the stackable pet shelter to prevent contact between the walls of the top section and the walls of the bottom section when the top and bottom sections are nested. The support structure may take on many forms, including those forms that provide addition functionality and/or atheistic appeal, such as, for example, ventilation slots, ridges, shingle-like structures, or the like.

In a further embodiment, nested top and bottom sections of the pet shelters stack to reduce the floor space area required at retail or wholesale establishments where the pet shelters are displayed or stored.

### BRIEF DESCRIPTION OF THE DRAWINGS

The preferred embodiments of the stackable pet shelter, illustrating its features, will now be discussed in detail. These embodiments depict the novel and non-obvious stackable pet shelter shown in the accompanying drawings, which are for illustrative purposes only. These drawings include the following figures, in which like numerals indicate like parts:

FIG. 1 is a front perspective view of a preferred embodiment of the stackable pet shelter;

FIGS. 2a-2c are, respectively, front elevational, right-side elevational and top plan views of the stackable pet shelter of FIG. 1;

FIG. 3 is a front perspective view of a bottom section of the stackable pet shelter of FIG. 1;

FIGS. 4a and 4b are, respectively, front section and right-side section views of the stackable pet shelter of FIG. 1, illustrating bottom-top-bottom-top stacking of an inverted top section nested in an upright bottom section;

FIGS. 5a and 5b are, respectively, front and right-side views of the stackable pet shelter of FIG. 1, illustrating bottom-top-bottom-top stacking of an inverted top section nested in an upright bottom section;

FIG. 6 is a front section view of the stackable pet shelter of FIG. 1, illustrating various accessory products between a bottom section and a top section of the pet shelter in a stack of pet shelters;

FIG. 7 is a front section view of the stackable pet shelter of FIG. 1, illustrating top-bottom-top-bottom stacking of an upright bottom section nested in an inverted top section;

FIG. 8 is a front section view of the stackable pet shelter of FIG. 1, illustrating bottom-top-bottom-top stacking of an upright top section nested over an inverted bottom section;

FIG. 9 is a front section view of the stackable pet shelter of FIG. 1, illustrating top-bottom-top-bottom stacking of an inverted bottom section nested over an upright top section;

FIG. 10 is a front section view of the stackable pet shelter of FIG. 1, illustrating a stack of pet shelters having separators placed between walls of a top section and walls of a bottom section, and between a roof of the top section and a floor of the bottom section;

FIG. 11 is a front section view of the stackable pet shelter of FIG. 1, illustrating a stack of pet shelters where the top section has an integral support structure; and

FIG. 12 is a sectional view of the stackable pet shelter of FIG. 1, illustrating a substantially horizontal stack of pet shelters where an inverted top section set on end nests in a bottom section set on end.

### DETAILED DESCRIPTION OF THE PREFERRED EMBODIMENT

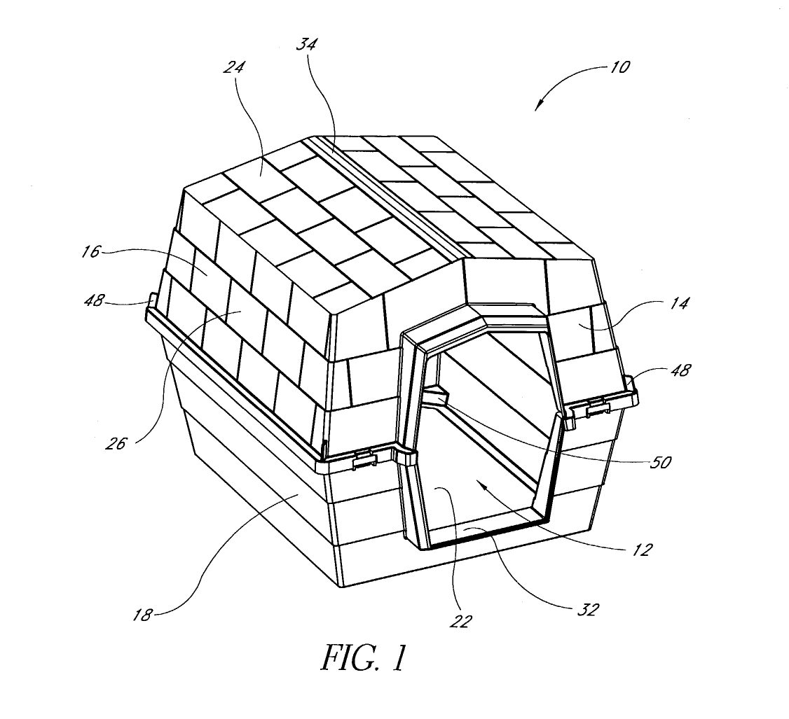

As FIG. 1 illustrates, a preferred embodiment of the stackable pet shelter 10 includes a hollow, substantially rectangular box with a substantially rectangular opening 12 in a front wall 14. One of skill in the art will appreciate, however, that the shelter 10 may include any number of sides or curved surfaces. The shelter 10 may, for example, be substantially triangular in plan aspect, hexagonal, octagonal or even round.

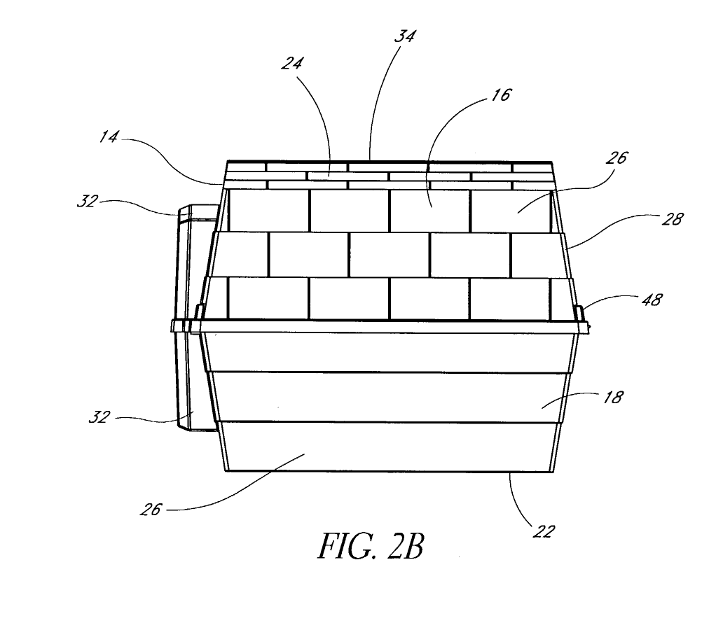

The shelter 10 is preferably constructed of a high-impact plastic, or another material that is lightweight and durable such as wood or fiberglass. The shelter 10 is constructed of two sections, a top section 16 and a bottom section 18. Both the top and bottom sections are shaped substantially as rectangular boxes with one missing side, and a substantially U-shaped opening in a side adjacent to the missing side. FIG. 3 illustrates the bottom section 18 in isolation.

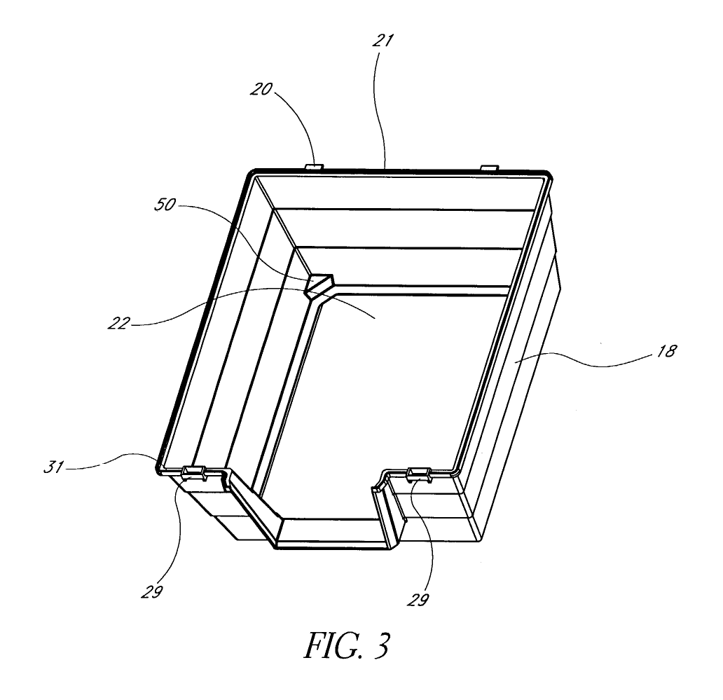

The top and bottom sections of the shelter may be secured to one another with tab and slot connectors. Generally horizontally extending tabs 20 (FIGS. 3, 4b and 5b) on a back upper edge 21 of the bottom section 18 mate with generally horizontally oriented slots (not shown) on a back lower edge 23 (FIG. 5b) of the top section 16. Generally vertically extending tabs 25 (FIG. 5a) on a front lower edge 27 of the top section 16 mate with generally vertically oriented slots 29 (FIG. 3) on a front upper edge 31 of the bottom section 18. In profile, the tabs 25 resemble an arrowhead that has been bisected lengthwise. Thus, a narrow leading portion of each tab 25 is able to penetrate a slot 29. Once the tab 25 advances through the slot 29 past a shoulder portion, the tab 25 snaps into place and can only be removed from the slot 29 by deforming the slot 29.

To assemble the shelter 10, the top and bottom sections are oriented such that their missing sides face each other and the open ends of both U-shaped openings are aligned. With the bottom section 18 resting on a flat horizontal surface, the back lower edge 23 of the top section is brought into contact with the back upper edge 21 of the bottom section 18 such that the tabs 20 extend through the slots on the top section. Next, the front lower edge 27 of the top section 16 is brought into contact with the front upper edge 31 of the bottom section 18, such that the tabs 25 snap into and extend through the slots 29.

One of skill in the art will appreciate that the illustrated manner of attaching the top section 18 to the bottom section 16 is merely exemplary. Many other methods of attachment are equally suitable, including providing horizontally extending lip members on both sections that receive vertically extending pins or bolt and nut fasteners, or providing a vertically extending and overlapping lip on the top portion that receives horizontally extending pins or bolt and nut fasteners. Alternatively, an interference fit or any other attachment mechanisms known to those of skill in the art may be used.

The side of the bottom section 18 opposite its missing side defines a shelter floor 22, while the side of the top section 16 opposite its missing side defines a shelter roof 24. The remaining sides of the two sections define shelter walls.

The shelter floor 22 may include grooves (not shown) for channeling water and/or other liquids away from a pet. The shelter floor 22 may be crowned to direct water and other liquids to a moat (not shown) along the inside perimeter of the floor 22. The moat directs the liquid to an exit where the liquid drains away from the shelter 10. The shelter floor 22 may also include drain holes (not shown) to drain water from the shelter 10.

In one embodiment, the shelter top section 16 comprises ventilation holes or slots. In another embodiment, the shelter 10 comprises ventilation holes or slots between the top section 16 and the bottom section 18. In another embodiment, the shelter walls comprise ventilation slots or holes, or attached pieces which provide ventilation. In a further embodiment, the shelter comprises a ventilation fan and/or one or more mounting structures for mounting the fan in a constructed pet shelter.

Two shelter 10 walls are preferably longer than the two remaining walls. The long walls define side walls 26, while the shorter walls define a front wall 14 and a back wall 28 of the shelter 10. The front wall 14 preferably includes a substantially rectangular opening 12 formed by the adjoining U-shaped openings of the top and bottom sections. The rectangular opening 12 defines a shelter entrance. One of skill in the art will appreciate that the shelter entrance may be any shape, such as triangular, hexagonal, octagonal, or even round. One of skill in the art will also appreciate that the shelter entrance may be formed in any of the shelter side walls.

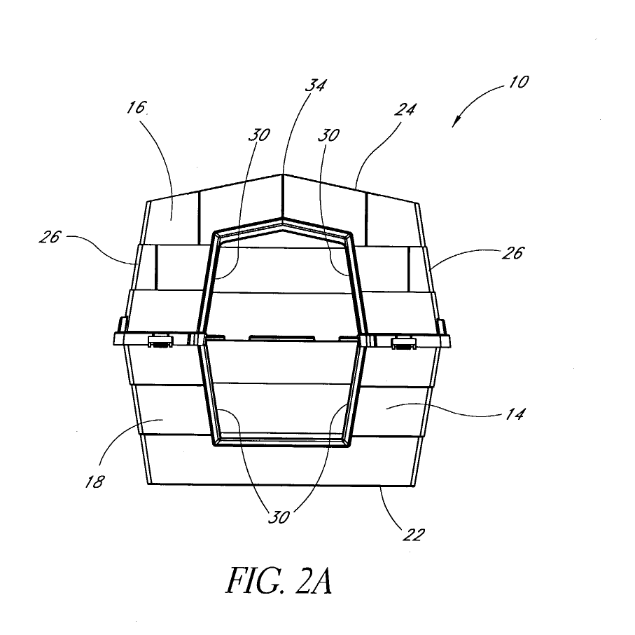

As best seen in FIGS. 2a and 2b, each of the shelter walls slopes gradually from vertical. For the top section 16, the walls slope from horizontal from the missing side to the shelter roof 24. For the bottom section 18, the walls slope outward from the shelter floor 22 to the missing side. In a preferred embodiment, the shelter walls of the top section 16 slope inward at approximately the same angle that the shelter walls of the bottom section 18 slope outward. In other words, the draft angle of the top section 16 is approximately the same as the draft angle of the bottom section 18. Also, in a preferred embodiment, the shelter top 16 and the shelter bottom 18 are approximately the same height. Thus, in one embodiment, the shelter 10 is preferably widest at a point roughly equidistant from the shelter roof 24 and floor 22.

In another embodiment, the shelter top 16 and the shelter base 18 are different heights. In a further embodiment, the slope of the shelter walls of the top section 16 is different than the slope of the shelter walls of the bottom section 18. In other words, the draft angle of the top section 16 can be different from the draft angle of the bottom section 18.

Legs 30 of each U-shaped opening are preferably bent outward, such that the legs 30 roughly parallel the shelter 10 walls, as best seen in FIG. 2a. Thus, the widest portion of the shelter entrance is at the junction of the top and bottom sections. As illustrated in FIGS. 2b and 2c, a narrow lip 32 preferably extends outward from the shelter entrance. The lip 32 prevents water, such as rainwater, from entering the shelter 10. One of skill in the art will appreciate, however, that the lip 32 is not a necessary component of the shelter 10.

The shelter floor 22 is preferably crowned slightly so that moisture runs away from a pet in the shelter. Alternatively, the floor 22 can be flat or slightly sloped. The shelter roof 24 is preferably slightly peaked, such that a ridge 34 stretches along the center of the roof 24 from the front wall 14 to the back wall 28. In a preferred embodiment, the roof 24 comprises a unitary structure, however, such unitary structure is not required. The roof 24 thus slopes downward from the ridge 34 toward either side wall 26. The slope preferably is steep enough to allow the shelter roof 24 to shed rainwater and to discourage pets from climbing on top of the shelter 10. However, the slope is preferably gradual enough to facilitate stacking and nesting of the shelter tops and bottoms, as explained below.

In an alternative embodiment, the roof 24 comprises at least one flat section. In another embodiment, the roof 24 comprises at least two separable pieces or sections. In a further embodiment, the bottom section 18 comprises at least two separable pieces or sections. In another embodiment, the side walls 36, 38 comprise at least two separable pieces. In yet another embodiment, the shelter 10 comprises removable panels which may be added or removed from the shelter 10. In a further embodiment, the shelter 10 comprises additional components such as removable decorative trim, accessories, pads, doors, bowls, and the like, or any material forming a portion of the top section 16, the bottom section 18,. or the walls.

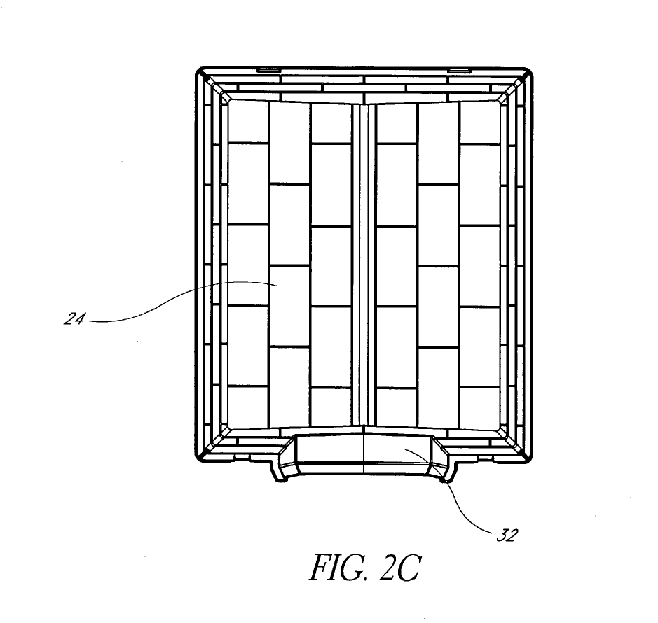

When the top section 16 is removed from the bottom section 18 and inverted, the top section 16 fits snugly within the interior of the bottom section 18, and the bottom section 18 fits snugly within the interior of the top section 16. FIGS. 5a and 5b illustrate a bottom-top-bottom-top stacking arrangement. FIGS. 5a and 5b illustrate an embodiment where the U shaped opening of the top section 16 is aligned vertically with the U-shaped opening of the bottom section 18. Thus, as illustrated in FIGS. 5a and 5b, the rear walls 44 of the top sections 16 are aligned vertically with the rear walls 46 of the bottom sections 18 and the front walls 40 of the top sections 16 are aligned vertically with the front walls 42 of the bottom sections 18 in the stack. FIGS. 4a and 4b illustrate the internal configuration of the various shelter walls in the stacked arrangement of FIGS. 5a and 5b.

As shown in FIG. 4a , the side walls 36 of each top section 16 rest against the side walls 38 of each bottom section 18, and vice versa. As shown in FIG. 4b, the front walls 40 of each top section 16 rest against the front walls 42 of each bottom section 18, and vice versa, and the rear walls 44 of each top section 16 rest against the rear walls 46 of each bottom section 18, and vice versa.

In another embodiment, the nested top and bottom sections 16, 18 alternate from front to back and back to front in the stack. Thus, the front walls 40 of each top section 16 rest against the rear walls 46 of each bottom section 18, and vice versa, and the rear walls 44 of each top section 16 rest against the front walls 42 of each bottom section 18, and vice versa.

Also as shown in both FIGS. 4a and 4b, the ridge 34 of the top section 16 rests on the floor 22 of the bottom section 18. Further, as FIG. 4a illustrates, there is very little empty or wasted space between the top sections 16 and bottom sections 18.

Additionally, the top section 16 may optionally comprise at least one support flange 48 (FIGS. 1, 2a, and 2b). In one embodiment, the support flange 48 is positioned on the outside of the side wall 36 of the top section 16. When the inverted top section 16 fits snugly in the bottom section 18, the support flange 48 is located on the outside of the top section 16 such that the support flange 48 rests on the top edge of the bottom section 18. The support flange 48 assists in supporting the weight of the top section 16 and any other sections 16, 18 stacked above the support flange 48 on the sections below the support flange 48. FIGS. 4a , 4b, 5a, and 5b illustrate one embodiment of the support flange 48. As is known to one of skill in the art, there are many locations on the pet shelter 10 to position one or more support flanges 48 to support the weight of and stabilize the stack. The support flange 48 may comprise a molded element integral to the top or bottom section. The support flange 48 may be flange-shaped, block-shaped, wedge-shaped, molded, added, separated, attached, or the like. As can be appreciated by one of skill in the art, there exist many shapes, materials, and locations for the support flange 48.

Also, the bottom section 18 may optionally comprise at least one support structure 50 (FIGS. 1 and 3). In one embodiment, the support structure 50 is positioned on the inside of the side wall 38 of the bottom section 18. When the inverted top section 16 fits snugly in the bottom section 18, the support structure 50 is located on the inside of the bottom section 18 such that the support structure 50 rests on the shoulder formed at the intersection of the side wall 36 and the roof 24 of the top section 16. The support structure 50 assists in supporting the weight of the top section 16 and any other sections 16, 18 stacked above the support structure 50 on the sections below the support structure 50. As is known to one of skill in the art, there are many locations on the pet shelter 10 to position one or more support structures 50 to assist in supporting and distributing the weight of the stack. The support structure 50 may be flange-shaped, block-shaped, wedge-shaped, or the like. As can be appreciated by one of skill in the art, there exist many shapes, materials, and locations for the support structure 50.

The snug fit between the inverted top sections 16 and bottom sections 18 results from a combination of features of the two sections. One of skill in the art will appreciate, however, that not all of these features are required for snug nesting. The scope of the shelter 10 is not limited to a shelter having all of these features.

First, the front wall 14, back wall 28 and side walls 26 of the top section 16 slope at angles that are roughly equal to the slope of the front wall 14, back wall 28 and side walls 26, respectively, of the bottom section 18. Second, the legs 30 of the U-shaped opening in the top section 16 slope at roughly equal angles as the legs 30 of the U-shaped opening in the bottom section 18. Third, the top section 16 is approximately the same height as the bottom section 18. Fourth, the shelter floor 22 is generally flat, and the shelter roof 24 slopes very gradually.

However, in other embodiments, the front wall 14, back wall 28 and side walls 26 of the top section 16 slope at angles that are not roughly equal to the slope of the front wall 14, back wall 28 and side walls 26, respectively, of the bottom section 18. In an alternative embodiment, the top section 16 is not approximately the same height as the bottom section 18. In other embodiments, the walls on either the top section 16, the bottom section 18 or both the top and bottom sections comprise at least one hinge integral to the wall. The hinge permits the walls to fold inward or outward to reduce the height of at least one of the walls. In a further embodiment, the roof 24 comprises at least one hinge integral to the roof 24. The hinge permits the roof 24 to fold inward or outward to reduce the height of the top section 16. The foregoing hinges may comprises scored or other weakened material, separable hinges, or the like.

The snug fit of inverted top sections within bottom sections and bottom sections within inverted top sections enables retailers to stack the shelters 10 in a bottom-top-bottom-top-bottom-etc. arrangement. Thus, a large number of shelters 10 can be kept on hand by the retailer in a single, space-efficient stack.

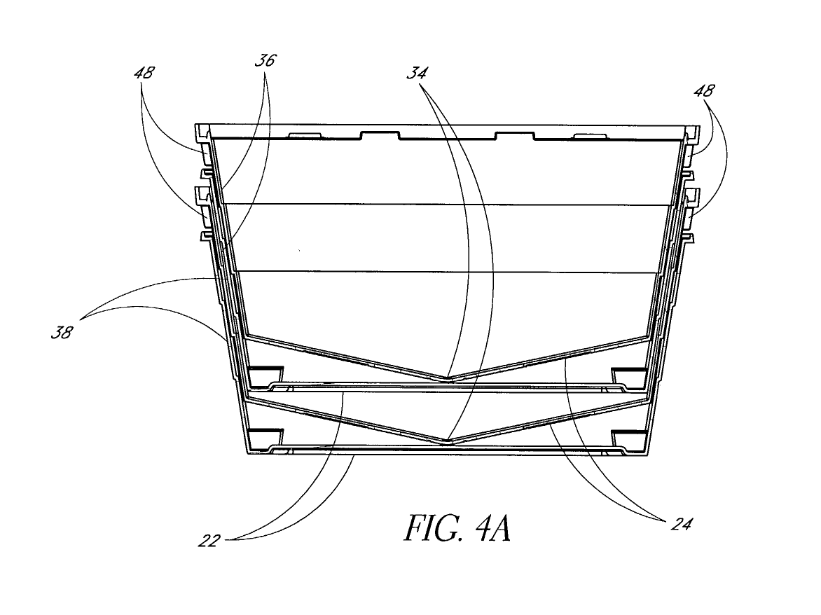

FIG. 6 illustrates a bottom-top-bottom-top stacking embodiment comprising an inverted top section 16 nested in an upright bottom section 18. As shown in FIG. 6, the nested top section 16 and bottom section 18 include one or more accessory items. For example, the space between each inverted top section 16 and bottom section 18 may include one or more accessories 52 for the shelter 10, such as a pad, a door, a pillow, a blanket, a toy, a dish or other food dispensing device, user/owner manuals, educational information regarding the pet shelter or particular pets or pet care, coupons, advertisements, combinations of the same or the like. As can be appreciated by one of skill in the art, the pet accessories 52 may also comprise bedding, bowls, treats, clothing, leashes, collars, toys, books, and the like. FIG. 6 shows the accessories 52 stored on the bottom section 18, in the space between the bottom section 18 and the inverted top section 16. In other embodiments, the accessories 52 are stored on the inverted top section 16, on the upright top section 16, on the inverted bottom section 18, or in the space between the bottom section 18 and the top section 16.

If such accessories 52 are stored, the inverted top section 16 and bottom section 18 may be removably secured, such as through a plastic cord, to retain the accessories 52 therebetween and prevent loss or theft of the accessories 52. In another embodiment, the accessories 52 attach through a plastic cord 54 or similar device to a tab 56 on the top section 16 or bottom section 18. The tab 56 may be integral to the top or bottom section. Thus, the accessories 52 are secured against accidental loss or theft.

FIG. 6 also illustrates a promotional offer 58 or other printed document between the bottom section and the top section. The printed document 58 may be stored along with the accessories 52. In one embodiment, the printed document 58 attaches to the side wall of the top or bottom section. The printed document may attach through a plastic cord 54 or other similar device to the molded tab 56 integral to the top or bottom section. In another embodiment, the printed document 58 adhesively affixes to the top or bottom section. The printed document 58 may comprise a coupon, instructions, an advertisement, a promotional offer, or the like.

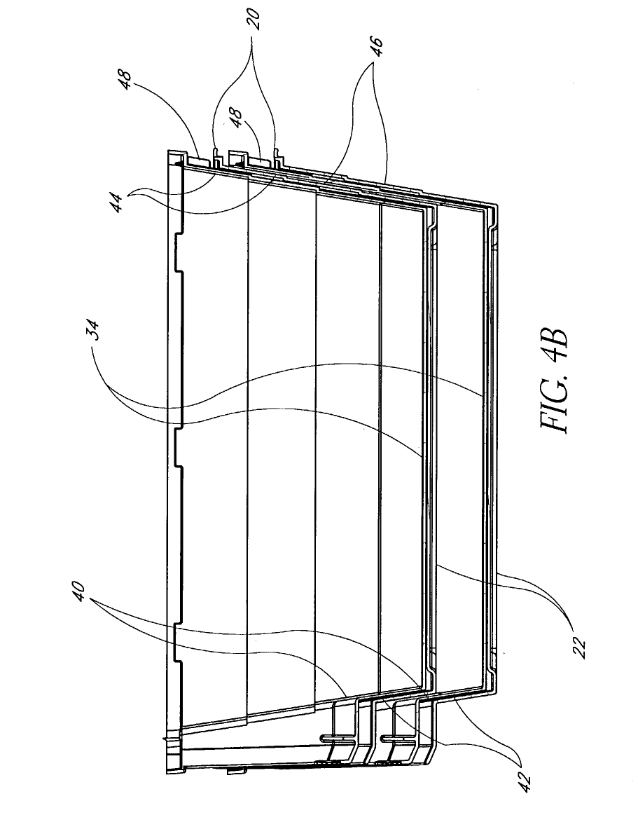

FIG. 7 illustrates a stacking embodiment where nesting pet shelter components include pet shelters where each pet shelter comprises an upright bottom section nesting in an inverted top section. The side walls 36 of each top section 16 rest against the side walls 38 of each bottom section 18, and vice versa. In one embodiment, the U-shaped openings of each top and bottom section vertically align in the stack such that the front walls 40 of each top section 16 rest against the front walls 42 of each bottom section 18, and vice versa, and the rear walls 44 of each top section 16 rest against the rear walls 46 of each bottom section 18, and vice versa.

In another embodiment, the nested top and bottom sections alternate from front to back and back to front in the stack. Thus, the front walls 40 of each top section 16 rest against the rear walls 46 of each bottom section 18, and vice versa, and the rear walls 44 of each top section 16 rest against the front walls 42 of each bottom section 18, and vice versa.

In one embodiment of the stacking arrangement of FIG. 7, the stack rests on stack support structures 60. The stack support structures 60 level the stack of shelters 10 when the lowest section of the stack comprises a top section 16 having a peaked roof 24. Thus, the stack support structures 60 advantageously provide stability to the stack. Moreover, an artisan will recognize from the disclosure herein that multiple stack support structures may be advantageously placed throughout the stack to increase stability, increase ease of component separation, or the like. Thus, the aforementioned support flanges 48 and support structures 50 may be used either singly or in combination to assist in supporting the weight of the stacking arrangement.

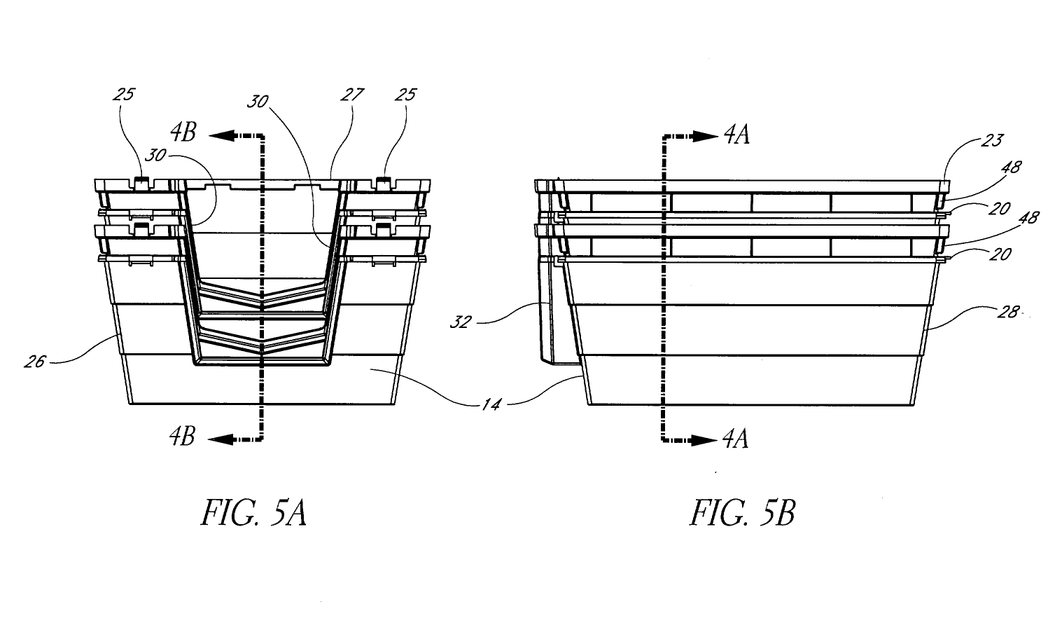

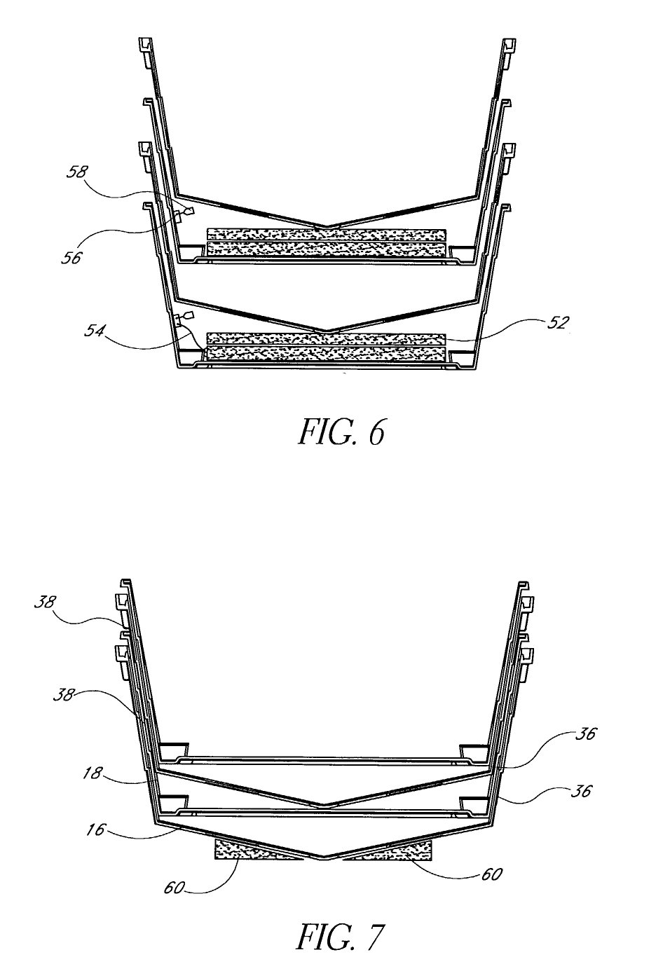

FIG. 8 illustrates a stacking arrangement comprising an upright top section 16 nested on an inverted bottom section 18. FIG. 9 illustrates a top-bottom-top-bottom stacking arrangement comprising an inverted bottom section 18 nested on an upright top section 16. In an embodiment of FIGS. 8 and 9, the side walls 36 of each top section 16 rest against the side walls 38 of each bottom section 18, and vice versa. In an embodiment of the stacking arrangements of FIGS. 8 and 9, the U-shaped openings of each top and bottom section 16 and 18 vertically align in the stack such that the front walls 40 of each top section 16 also rest against the front walls 42 of each bottom section 18, and vice versa, and the rear walls 44 of each top section 16 rest against the rear walls 46 of each bottom section 18, and vice versa.

In other embodiments of stacking arrangements of FIGS. 8 and 9, the nested top and bottom sections 16 and 18 alternate from front to back and back to front in the stack. In one such embodiment, the front walls 40 of each top section 16 rest against the rear walls 46 of each bottom section 18, and vice versa, and the rear walls 44 of each top section 16 rest against the front walls 42 of each bottom section 18, and vice versa.

The aforementioned support flanges 48 and support structures 50 may be used either singly or in combination to assist in supporting the weight of the illustrated or a wide variety of other stacking arrangements.

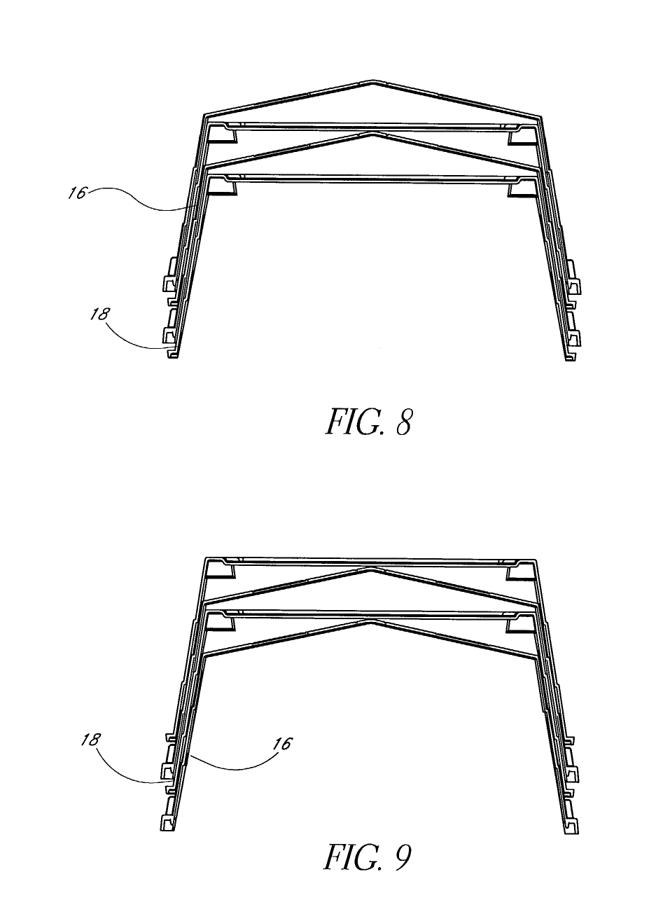

FIG. 10 illustrates roof-floor spacing and/or support blocks 62 placed between the top section 16 and the bottom section 18 of the pet shelter 10 such that the side walls 36 of the top section 16 do not contact the side walls 38 of the bottom section 18. The support blocks 62 may advantageously comprise structures of a wide variety of materials, including, wood, cardboard, foamed polymers Styrofoam, particleboard, paper, synthetic materials, plastic, or other materials, combinations of the same, or the like.

FIG. 10 also illustrates wall spacing block 64 placed between the top section 16 and the bottom section 18 such that the ridge 34 of the top section 16 does not rest on the floor 22 of the bottom section 18. The spacing blocks 64 may comprise those materials similar to or the same as spacing blocks 62. In an embodiment, the spacing blocks 62 and 64 creates separation between the top section 16 and the bottom section 18 such that an air gap exists between the top section 16 and the bottom section 18. The spacing blocks 62 and 64 may be used in any of the aforementioned stacking embodiments to create a separation or air gap between the top section 16 and the bottom section 18 in the stack of pet shelters 10, thus, among other things, facilitating ease of separation of pet shelter components, stability in the stack, and the like.

In addition, a liner or a sheet 66 of plastic, paper, or the like may be placed between the top section 16 and the bottom section 18 to prevent the side walls 36 of the top section 16 from contacting the side walls 38 of the bottom section 18. The liner 66 may also prevent the ridge 34 of the top section 16 from contacting the floor 22 of the bottom section 18. The sheet or liner 66 may be used in any of the aforementioned stacking embodiments to create a separation between the top section 16 and the bottom section 18 in the stack of pet shelters 10.

The wall spacing block 64, the roof-floor spacing block 62 and the liner 66 may each be used separately, or in any combination to prevent contact between the top section 16 and the bottom section 18 in any of the aforementioned stacking embodiments.

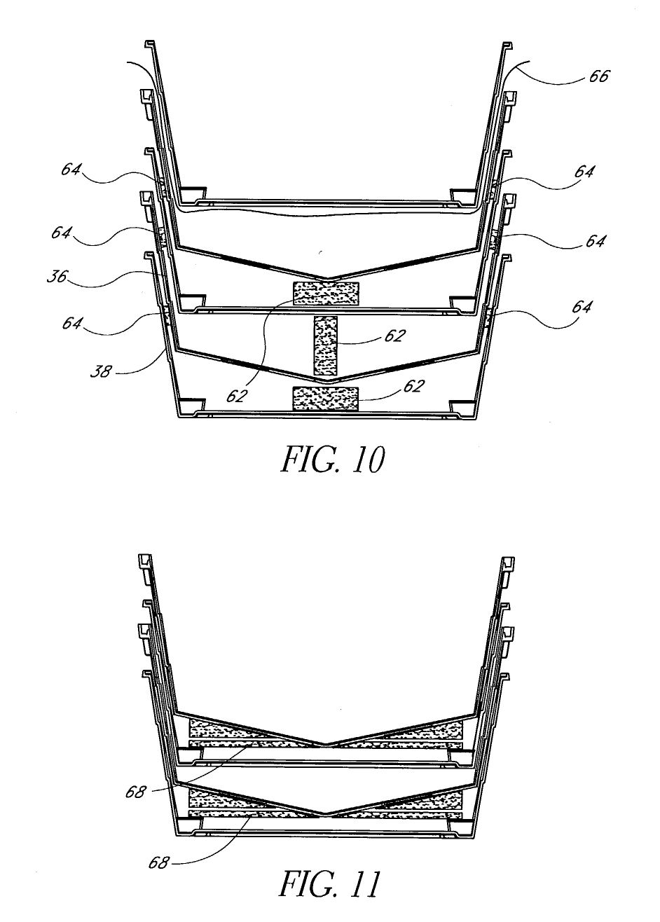

FIG. 11 illustrates a stacking embodiment where the pet shelter 10 comprises an integral support structure 68. The integral support structure 68 supports and distributes the weight of the stack. The integral support structure 68 comprises a molded design element on the top section 16, the bottom section 18 or both the top section 16 and the bottom section 18. In the embodiment illustrated in FIG. 11, the integral support structure 68 comprises an air vent positioned on the roof 24 of the top section 16, which provides ventilation for the pet shelter 10. The molded design element may comprise least one extension leg, at least one chimney, at least one air vent, or any number of design enhancements which provide stacking support when the top and bottom section of the pet shelter 10 are nested and stacked.

In one embodiment, when the top section 16 and the bottom section 18 are stacked, the air vent 68 contacts the floor 22 of the bottom section 18 and assists in supporting and distributing the weight of the stack of pet shelters 10. In another embodiment, a stacking block placed between the support structure 68 and the floor 22 assists in supporting and distributing the weight of the stack.

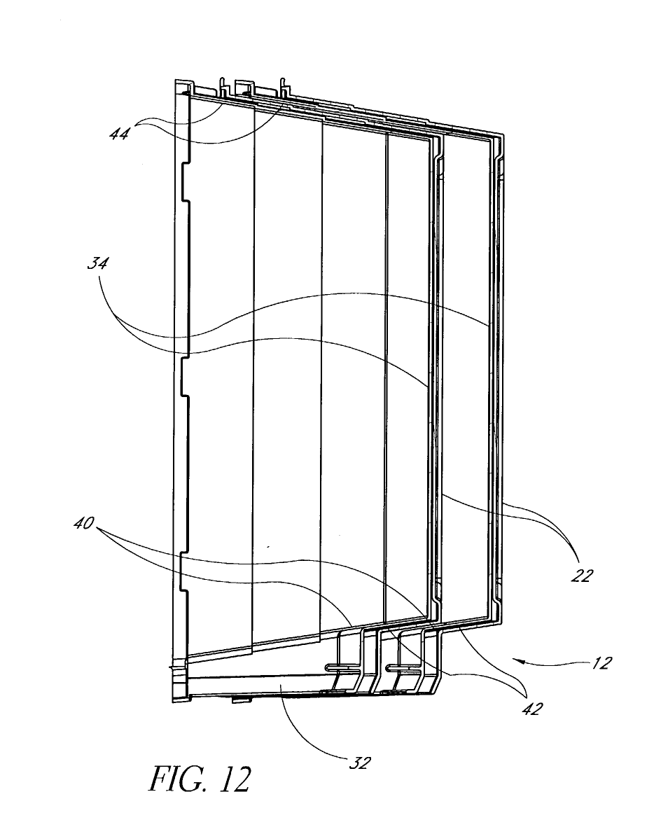

In a further embodiment, any of the stacking arrangements of FIGS. 4-11 may be oriented such that the pet shelters are stacked on end or on a side to create a substantially horizontal stack of shelters 10. FIG. 12 illustrates one embodiment where the stacking arrangement illustrated in FIG. 5B is rotated 90°. In FIG. 12, the opening 12 of the bottom section 18 sets on a stacking surface. The top section 16, set on end such that the opening 12 of the top section 16 faces the stacking surface, nests inside the bottom section 18. The U-shaped openings of each top and bottom section substantially horizontally align in the stack such that the front walls 40 of each top section 16 rest against the front walls 42 of each bottom section 18, and vice versa, and the rear walls 44 of each top section 16 rest against the rear walls 46 of each bottom section 18, and vice versa. In another embodiment, the side walls 36 and 38 of the top and bottom sections 16 and 18 and respectively are parallel to a stacking surface. In a further embodiment, the front walls 40 and 42, the rear walls 44 and 46, or a combination of alternating front and rear walls 40, 42, 44 and 46 of the top and bottom sections 16 and 18, respectively, are parallel to the stacking surface.

Additionally, an artisan will recognize from the disclosure herein a wide variety of alternative stacking embodiments and arrangements that provide for selection of one pet shelter from the stack of pet shelter components by selecting the components from one side of the stack. Moreover, an artisan will recognize that aspects of each of the various embodiments disclosed herein and those identifiable by such artisan from those disclosed herein can be combined. For example, the stacking blocks, the accessory items, and the paper liner may advantageously be combined in any of the disclosed stacking arrangements. In addition, accessory items corresponding to a pet shelter may be placed in between components of a pet shelter, may be placed above the components, below the components, or any combination of the same.

Moreover, the present disclosure also discloses advantages associated with the reduction in the amount of warehouse and retail store space needed to store and display multiple pet shelters. Moreover, the present disclosure encompasses disclosure related to reduction of transport costs of the shelters as more shelters fit within a standard shipping container.

In various disclosed configurations, the shelters 10 not only occupy relatively little inventory space, but a single shelter 10 can be removed from one side (e.g., the top) of the stack with minimal effort. Any accessories that the shelter 10 features may be already neatly packaged within. Furthermore, the snug fit of each section within the others leads to greater stability of a large stack. The stack is thus less prone to tipping over and causing injury.

The above presents a description of the best mode contemplated for the present stackable pet shelter, and of the manner and process of making and using it, in such full, clear, concise, and exact terms as to enable any person skilled in the art to which it pertains to make and use this stackable pet shelter. This stackable pet shelter is, however, susceptible to modifications and alternate constructions from that discussed above which are fully equivalent. Consequently, it is not the intention to limit this stackable pet shelter to the particular embodiments disclosed. On the contrary, the intention is to cover all modifications and alternate constructions coming within the spirit and scope of the stackable pet shelter as generally expressed by the following claims, which particularly point out and distinctly claim the subject matter of the stackable pet shelter.

What is claimed is:

1. A stack of nested shelter components stacked on a stacking surface, wherein acquisition of a shelter from the stack comprises selection of components from one end of the stack, the stack comprising:
a first shelter including:
a roof section having a first cross section and including a plurality of differently sloped surfaces, and
a base section having a second cross section different from the first cross section and including a floor and sloped side walls, wherein the roof section and the base section are nested together within the stack and one of the roof section and the base section is supported by a stacking surface; and
a second shelter including:
a roof section including a plurality of differently sloped surfaces, and
a base section including a floor and sloped side walls, wherein the roof section and the base section are nested together within the stack and one of the roof section and the base section of the second shelter nests together with the other of the roof section and the base section of the first shelter.

2. The stack of nested shelter components of claim 1, wherein the base section of the first shelter is inverted and is supported by the stacking surface, the roof section of the first shelter nests over the inverted base section, and the base section of the second shelter is inverted and nests over the roof section of the first shelter.

3. The stack of nested shelter components of claim 1, wherein the base section of the first shelter is supported by the stacking surface, the roof section of the first shelter is inverted and nests within the base section, and the base section of the second shelter nests within the inverted roof section of the first shelter.

4. The stack of nested shelter components of claim 1, wherein the roof section of the first shelter is inverted and is supported by stacking blocks supported by the stacking surface, the base section of the first shelter nests within the inverted roof section, and the roof section of the second shelter is inverted and nests within the base section of the first shelter.

5. The stack of nested shelter components of claim 1, wherein the roof section of the first shelter is supported by the stacking surface, the base section of the first shelter is inverted and nests over the roof section, and the roof section of the second shelter nests over inverted base section of the first shelter.

6. The stack of nested shelter components of claim 1, wherein separating material separates at least one of the roof sections from at least one of the base sections.

7. The stack of nested shelter components of claim 6, wherein the separating material comprises at least one sheet of paper.

8. The stack of nested shelter components of claim 6, wherein the separating material comprises at least one stacking block.

9. The stack of nested shelter components of claim 6, wherein the separating material is wood or Styrofoam.

10. The stack of nested shelter components of claim 6, wherein the separating material prevents direct contact between at least portions of the at least one of the roof sections and the at least one of the base sections.

11. The stack of nested shelter components of claim 1, wherein one or more stacking blocks add stability to the stack.

12. The stack of nested shelter components of claim 11, wherein the one or more stacking blocks comprise at least one of ventilation structures and chimney structures.

13. The stack of nested shelter components of claim 11, wherein at least one of the roof sections and bottom sections comprise the one or more stacking blocks.

14. The stack of nested shelter components of claim 1, wherein the floor of the second shelter comprises a moat around at least a portion of a periphery thereof.

15. The stack of nested shelter components of claim 1, wherein the floor of the second shelter comprises one or more drain holes.

16. The stack of nested shelter components of claim 1, further comprising at least one accessory item associated the second shelter.

17. The stack of nested shelter components of claim 16, wherein the at least one accessory item is grouped such that acquisition of the second shelter from the stack automatically includes acquisition of the at least one accessory item.

18. The stack of nested shelter components of claim 16, wherein the at least one accessory item comprises a promotional offer or brochure.

19. The stack of nested shelter components of claim 16, wherein the at least one accessory item is attached to one of the roof section and base section via a cord.

20. The stack of nested shelter components of claim 16, wherein the at least one accessory item comprises one of floor pads and a door.

21. The stack of nested shelter components of claim 1, wherein the roof section of the first shelter comprises a center peak ridge.

22. The stack of nested shelter components of claim 1, wherein the first shelter further comprises one or more ventilation slots.

23. The stack of nested shelter components of claim 22, wherein one or more ventilation slots are part of the roof section of the first shelter.

24. The stack of nested shelter components of claim 1, wherein the first shelter further comprises a ventilation fan.

25. A stack of shelters comprising:
an inverted first bottom including side walls;
a first top nested over the inverted first bottom, the first top including a first center ridge, first sloped side walls, and second steeper sloped side walls sloped similar to the side walls of the inverted first bottom;
an inverted second bottom nested over the first top and including side walls; and
a second top nested over the inverted second bottom, wherein the second top includes a second center ridge, third sloped side walls, and fourth steeper sloped side walls sloped similar to the side walls of the inverted second bottom,
wherein a first shelter comprises the first top and the inverted first bottom and a second shelter comprises the second top and the inverted second bottom.

26. The stack of shelters of claim 25, further comprising at least one accessory item.

27. The stack of shelters of claim 26, wherein the at least one accessory item is grouped such that acquisition of the second shelter from the stack automatically includes acquisition of the at least one accessory item.

28. The stack of shelters of claim 25, wherein at least a portion of the center ridge of the first top contacts a floor of the inverted second bottom.

29. The stack of shelters of claim 25, wherein the first and second shelters each comprise a durable plastic material.

30. The stack of shelters of claim 25, wherein the first sloped side walls and the third sloped side walls each includes shingle-like surfaces.

31. The stack of shelters of claim 25, wherein the second steeper sloped side walls and the fourth steeper sloped side walls each includes shingle-like surfaces.

32. A stack of pet shelters comprising:
a first top including a first center ridge, first sloped side walls, and second steeper sloped side walls;
an inverted first bottom nested over the first top, the first bottom including side walls sloped similar to the second steeper sloped side walls of the first top,
a second top nested over the inverted first bottom, wherein the second top includes a second center ridge, third sloped side walls and fourth steeper sloped side walls; and
an inverted second bottom nested over the second top and including side walls sloped similar to the fourth steeper sloped side walls of the second top, wherein a first pet shelter comprises the first top and the inverted first bottom and a second pet shelter comprises the second top and the inverted second bottom.

33. A stack of pet shelters comprising:
an inverted first top including a first center ridge, first sloped side walls, and second steeper sloped side walls;
a first bottom nested within the inverted first top, the first bottom including side walls sloped similar to the second steeper sloped side walls of the inverted first top,
an inverted second top nested within the first bottom, wherein the inverted second top includes a second center ridge, third sloped side walls and fourth steeper sloped side walls; and
a second bottom nested within the inverted second top and including side walls sloped similar to the fourth steeper sloped side walls of the second inverted top, wherein a first pet shelter comprises the inverted first top and the first bottom and a second pet shelter comprises the inverted second top and the second bottom.

34. A stack of pet shelters comprising:
a first top comprising sloped side walls;
a first bottom comprising sloped side walls sloped similar to the sloped side walls of the first top, wherein the first top nests with the first bottom;
a second top comprising sloped side walls sloped similar to the sloped sidewalls of the first bottom; and
a second bottom comprising sloped side walls sloped similar to the sloped side walls of the second top, wherein the second top nests with the second bottom and wherein the first bottom nests with the second top to form a stack.

35. The stack of pet shelters of claim 34, wherein the first and second bottoms are upright, and wherein the first and second tops are inverted, wherein the first bottom rests on a stacking surface.

36. The stack of pet shelters of claim 34, wherein the first and second bottoms are inverted, and wherein the first and second tops are upright, wherein the first bottom rests on a stacking surface.

37. The stack of pet shelters of claim 34, wherein the first and second bottoms are upright, and wherein the first and second tops are inverted, wherein the first top rests on at least one of stacking blocks or a stacking surface.

38. The stack of pet shelters of claim 34, wherein the first and second bottoms are inverted, and wherein the first and second tops are upright, wherein the first top rests on a stacking surface.

39. A stack of pet shelters including nested pet shelter components, the stack comprising:
a first top having a first cross section and including a roof, side walls, a door-side, and a back side opposite the door-side;
a first bottom having a second cross section different from the first cross section and including a floor, side walls, a door-side, and a back side opposite the door-side, wherein the first top is nested with the first bottom in a stack of pet shelter components including at least one of the door-side and the back side of the first top facing a stacking surface;
a second top including a roof, side walls, a door-side, and a back side opposite the door-side; and
a second bottom including a floor, side walls, a door-side, and a back side opposite the door-side, wherein the second top is nested with the second bottom in a stack of pet shelter components including at least one of the door-side and the back side of the second top facing a stacking surface, and wherein one of the second top and the second bottom is nested with the other of the first top and the first bottom.

40. The stack of pet shelters of claim 39, wherein the door-sides of the first and second tops face a stacking surface.

41. The stack of pet shelters of claim 39, wherein the back sides of the first and second tops face a stacking surface.

42. The stack of pet shelters of claim 39, further comprising at least one accessory item associated a shelter.

43. The stack of pet shelters of claim 42, wherein the at least one accessory item is grouped such that acquisition of the shelter from the stack automatically includes acquisition of the at least one accessory item.

44. The stack of pet shelters of claim 42, wherein the at least one accessory item comprises a promotional offer or brochure.

45. The stack of pet shelters of claim 42, wherein the at least one accessory item is attached to one of the roof section and base section via a cord.

46. The stack of pet shelters of claim 42, wherein the at least one accessory item comprises one of floor pads and a door.
